(19) United States
(12) Patent Application Publication
(10) Pub. No.: US 2007/0209210 A1
(43) Pub. Date: Sep. 13, 2007

(54) Scraper tool

(75) Inventors: David R. Henke, Maple Grove, MN (US); Thomas Grimm, Robbinsdale, MN (US); Gerald Ranallo, Plymouth, MN (US)

Correspondence Address: HAMRE, SCHUMANN, MUELLER & LARSON, P.C., P.O. BOX 2902, MINNEAPOLIS, MN, 55402-0902, US

(73) Assignee: WARNER MANUFACTURING COMPANY, MINNEAPOLIS, MN (US)

(21) Appl. No.: 11/373,663

(22) Filed: Mar. 10, 2006

(51) Int. Cl. B26B 3/00

(52) U.S. Cl. 30/169

(57) ABSTRACT

Disclosed is a scraper tool suited for scraping planar surfaces. Also disclosed is a scraper tool having a pivoting blade assembly, and mechanisms enabling the pivoting of a blade assembly relative to an ergonomic handle thus allowing the user to conveniently scrape surfaces having a variety of orientations to him or her.

### FIELD

The invention generally pertains to the field of construction tools, and more particularly to scraper tools used in the scraping of surfaces.

### BACKGROUND

Scraping tools are used to remove old paint or spattered drywall compound from structures as a preliminary step in the resurfacing operations, as well as to scrape other materials from surfaces such as adhesives. A problem exists, however, when scraping surfaces which are overhead, such as ceilings with conventional scrapers because the position of the handle makes them difficult to use for this purpose.

The present disclosure discloses a scraper tool which solves many of these problems that are associated with existing scraper tools. It will be appreciated that the disclosure may disclose more than one invention. The invention(s) is (are) pointed out with particularity in the claims annexed hereto and forming a part hereof.

### BRIEF SUMMARY

The invention(s) generally relate to scraper tools suited for scraping ceilings, as well as scraper tools having a pivoting blade assembly, and to mechanisms enabling the pivoting and locking of the blade assembly.

In one embodiment, the apparatus comprises a scraper whose handle is positioned at such an angle so as to be ergonomically suited for scraping overhead surfaces.

A second embodiment of the tool comprises a pivoting blade assembly wherein the scraper blade assembly is rotatable between two alternate fixed positions—the standard position, and the overhead position wherein the scraper blade assembly is located at 180° to the standard position.

In a third embodiment, the rotating scraper blade is achieved through locking the blade assembly at any one of many predetermined locations.

In another embodiment, a multi-positioning apparatus locates a scraper blade at any precise user-defined angle and an optional locking device permits blade assembly locking at the user-defined angle.

One advantage of the present apparatus is to save the user valuable time in completing scraping operations on a variety of surfaces, thus allowing him or her to better compete in the workplace. In addition, time is saved by making the scraping of ceilings more efficient by positioning the scraper blade at an ideal angle for overhead scraping and by enabling the user to cover a larger surface area without moving a ladder.

Another advantage of one embodiment is that the scraper tool allows the scraping of ceilings without the user having to contort his or her arm to obtain the proper orientation of the scraper blade to the overhead surface, and allows for more efficient transfer of force through the scraper tool to the work surface. Consequently, the scraper tool saves the user the inconvenience of suffering strained arm, hand, and finger muscles and ligaments which readily occurs with standard scrapers while scraping ceilings.

Still another advantage of one embodiment is that the user may scrape any given ceiling from a less elevated position, thereby helping prevent dangerous falls by maintaining the user's center of gravity at a lower, more stable position.

Furthermore, embodiments which allow the user to choose from many scraper blade assembly angles provide the advantage of allowing the user specifically tailor the blade assembly angle in attacking any given scraping problem based on a variety of factors such as arm strength, level of fatigue, position of the user to the working surface, and angle of the working surface to the user.

The invention(s) is (are) pointed out with particularity in the claims annexed hereto and forming a part hereof.

### BRIEF DESCRIPTION OF THE DRAWINGS

FIG. 1A is a first embodiment of a scraper tool well suited for the scraping of ceilings.

FIG. 1B is a diagrammatic view of the embodiment shown in FIG. 1A illustrating an angle between a handle axis and a blade direction of a blade.

FIG. 2 is a perspective view of a second embodiment of a scraper tool with a pivoting head which locks in place in two alternate positions.

FIG. 3 is an exploded view of the second embodiment of a scraper tool with a pivoting head which locks in place in two alternate positions.

FIG. 4 is a side view of the second embodiment of a scraper tool with the pivoting head locked in the ceiling scraping position shown in broken lines.

FIG. 5 is a side view of the second embodiment of a scraper tool showing tool orientation for ceiling scraping.

FIG. 6 is a side view of a third embodiment of a scraper tool with a pivoting blade assembly.

### DETAILED DESCRIPTION

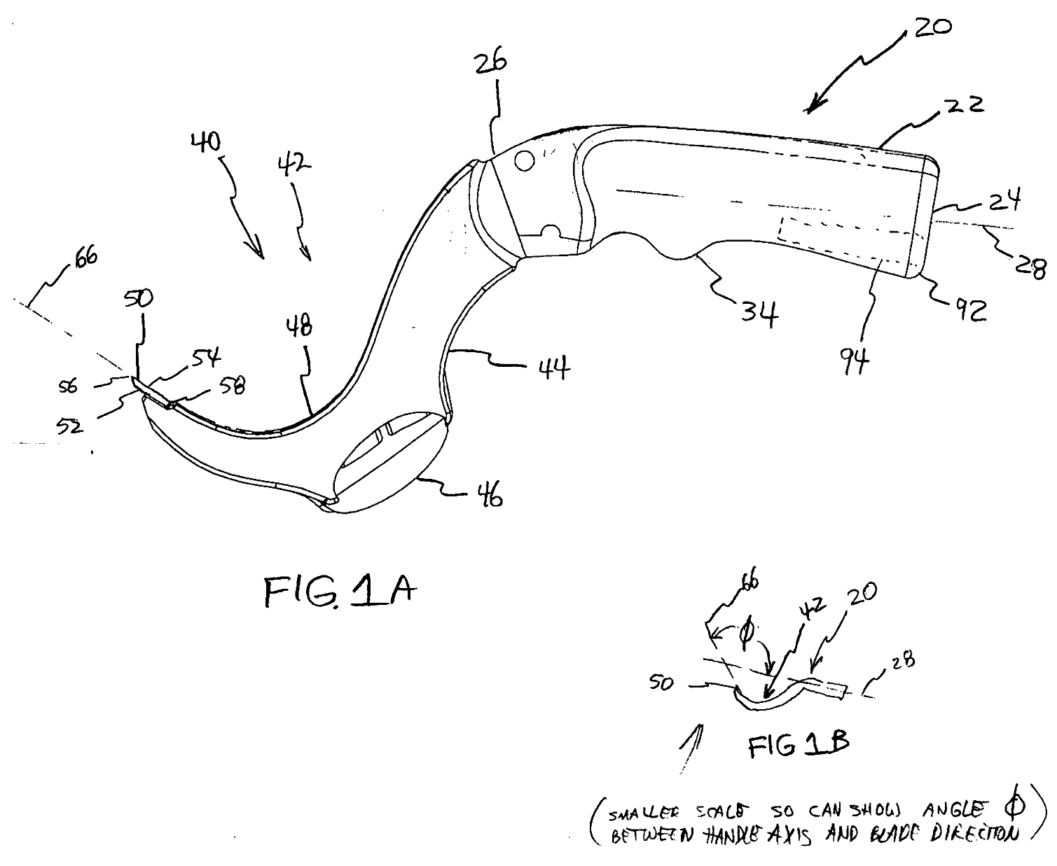

Referring to the drawings, wherein like reference numerals generally designate identical or corresponding parts throughout the several views, and more particularly to FIG. 1, there is shown a first embodiment of a scraper tool, more particularly, a scraping tool well suited for scraping ceiling surfaces, designated generally by the numeral 20.

The scraper tool 20 includes a first handle portion 22 which has a first end 24, a second end 26. The first handle portion 22 has an area for gripping which has a downward projecting protuberance commonly known as a pistol grip 34 which is used to help the user apply force to the scraper tool 20. The handle has a first handle portion axis 28, which generally runs longitudinally along the portion of the handle which the user grips with his or her hand, and defines the direction of the first handle portion 22. The first end 24 of the first handle portion 22 may include an in-handle blade-storage compartment 94, accessible through a storage door 92. The second end 26 of the first handle portion 22 is connected to a blade assembly 40, which comprises a force-transmitting portion 42 whose main purpose is to transfer and distribute forces applied by a user to a blade member 50 located at an end which is located distally from the first handle member 22. The force-transmittal portion 42 also includes a second handle portion 46 located near the blade member 50 for applying additional force to the blade member 50 while scraping surfaces. The blade member 50 has an upper surface 52, a lower surface 54, a front edge 56, and a rear portion 58. The blade member 50 also has a blade direction 66 located perpendicularly to the front edge 56 and in a plane of the lower surface 54 of the blade member 50. The rear portion 58 of the blade member 50 engages the force-transmitting portion 42 so that force may be transmitted through the force-transmitting portion 42 to the blade member 50. Furthermore, the blade member 50 is held in place by a blade retainer 60 (not shown) which is held in place by a fastener, such as a threaded screw and nut (not shown). The angle Φ formed between the blade direction 66 and the first handle portion axis 28 is an obtuse angle. The angle Φ is preferably between 95° and 175°, and most preferably between 120° and 165°. This angle Φ allows the scraper to be effectively used in the scraping of overhead ceilings since the users hand and arm can be comfortably situated away from the ceiling surface and thus prevent muscle strain, scraped knuckles, and allows the user to maintain a lower center of gravity, therefore lowering the risk of suffering a dangerous fall. In this first embodiment, the first handle portion 22 and the force-transmitting portion 42 may be formed in one piece which may be a molded polymeric plastic material or a cast metallic alloy. Both the first handle portion 22 and the second handle portion 46 may be textured or provided with ribbing to facilitate secure gripping of the scraper tool 20.

In use, the user positions himself or herself near a ceiling structure, grips the scraper tool 20 by the first handle portion 22 and situates the blade member 50 at an acute angle with the ceiling surface, while applying a force through the force-transmitting portion 42 to the blade member 50 while translating the scraper tool 20 back and forth along the surface to be scraped.

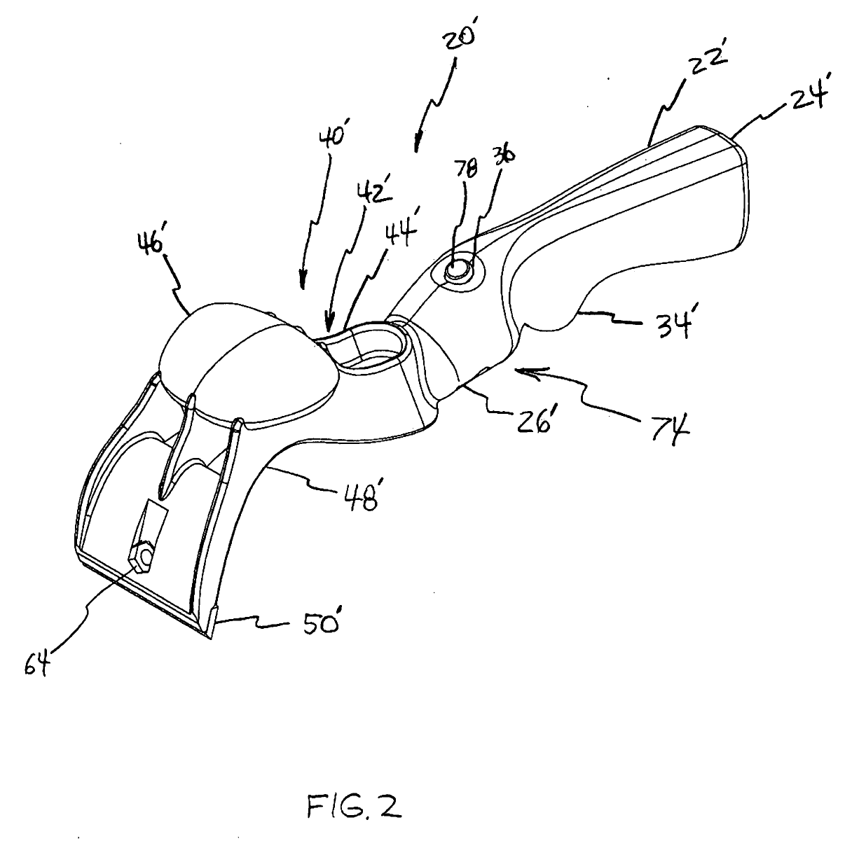

Referring now to FIG. 2, there is shown a perspective view of a second embodiment of a scraper tool, more particularly, a scraping tool having a pivoting blade assembly which is well suited for scraping surfaces oriented at any angle to the user, designated generally by the numeral 20′.

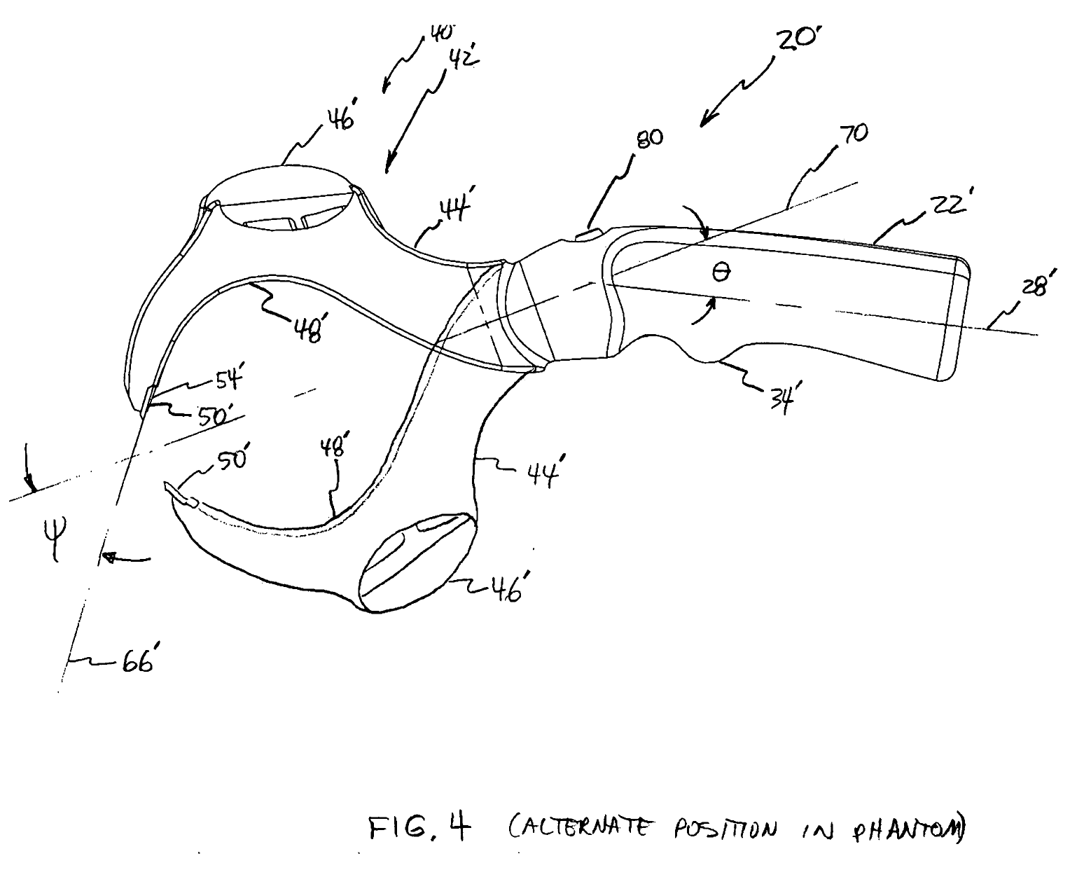

The scraper tool 20′ includes a first handle portion 22′ which has a first end 24′, a second end 26′, and a pistol grip 34′. The handle has a first handle portion axis 28′ (shown in FIG. 4), which generally runs longitudinally along the portion which the user grips with his or her hand, and defines the direction of the first handle portion 22′. The second end 26′ of the first handle portion 22′ abuts a blade assembly 40′. A pivotal-mechanism portion 74 attaches the first handle portion 22′ with a blade assembly 40′, while providing pivotal functionality therebetween. The pivotal-mechanism portion 74 is further defined by a pivotal axis 70 (shown in FIG. 4). An acute angle θ, shown in FIG. 4, is formed between the first handle portion axis 28′ and the pivotal axis 70. The angle 0 is preferably at least 15° and no greater than 45°, and most preferably at least 20° and no greater than 30°.

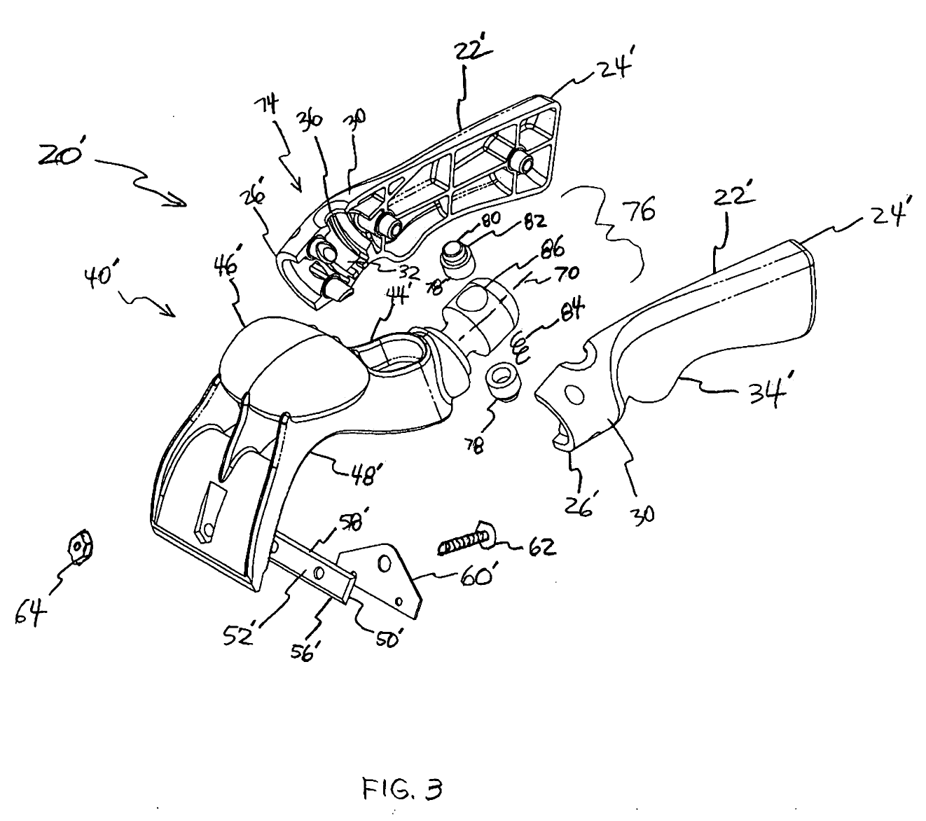

Turning now to FIG. 3, the pivotal-mechanism portion 74 may optionally incorporate a pivot-mechanism locking assembly 76. The pivot-mechanism locking assembly 76 includes a locking mechanism. The locking mechanism includes one or more buttons 78, each having a button head 80 and a button shoulder 82, which are housed on either end of a biasing mechanism, which in this embodiment is a spring 84, inside a lateral through-hole 86 in the force-transmittal portion 42′. The spring 84 biases the button heads 80 outward away from the pivotal axis 70 so that when the pivot-mechanism locking assembly 76 is locked in place, a button head 80 protrudes through a first handle portion aperture 36 to at least an outer surface of the first handle portion 30, while the button shoulder 82 rests against an inner surface of the first handle portion 32.

The blade assembly 40′, comprises a force-transmitting portion 42′ whose main purpose is to transfer and distribute forces applied by a user to a blade member 50′ located at the end which is located distally from the first handle member 22′. The force-transmittal portion 42′ also includes a second handle portion 46′ located near the blade member 50′ for applying additional force to the blade member 50′ while scraping surfaces. The blade member 50′ has an upper surface 52′, a lower surface 54′, a front edge 56′, and a rear portion 58′. The blade member 50′ also has a blade direction 66′ located perpendicularly to the front edge 56′ and in a plane of the lower surface 54′ of the blade member 50′. An acute angle Ψ, shown in FIG. 4, is formed between the blade direction 66′ and the pivotal axis 70. The angle Ψ is preferably at least 30° and no greater than 70°, more preferably at least 40° and no greater than 65°, and most preferably at least 50° and no greater than 55°.

The rear portion 58′ of the blade member 50′ engages the force-transmitting portion 42′ so that force may be transmitted through the force-transmitting portion 42′ to the blade member 50′. Furthermore, the blade member 50′ is held in place by a blade retainer 60′ which is held in place by a fastener, such as a threaded screw 62 and a nut 64.

In this second embodiment, the first handle portion 22′ and the force-transmitting portion 42′ may each be formed of a one-piece construction from molded polymeric plastic material or a cast metallic alloy. In this embodiment, the second handle portion 46′ is integrally molded with the force-transmittal portion 42′. In addition, both the first handle portion 28′ and the second handle portion 46′ may be textured or provided with ribbing to facilitate secure gripping of the scraper tool 20′. Alternately, embodiments may include first handle portions 28′ and the second handle portions 46′ which include soft materials, such as rubber or thermoplastic rubber compounds, closed-cell foams, and the like connected to them, or preferably over-molded in place, to provide enhanced gripping and impact dampening in use.

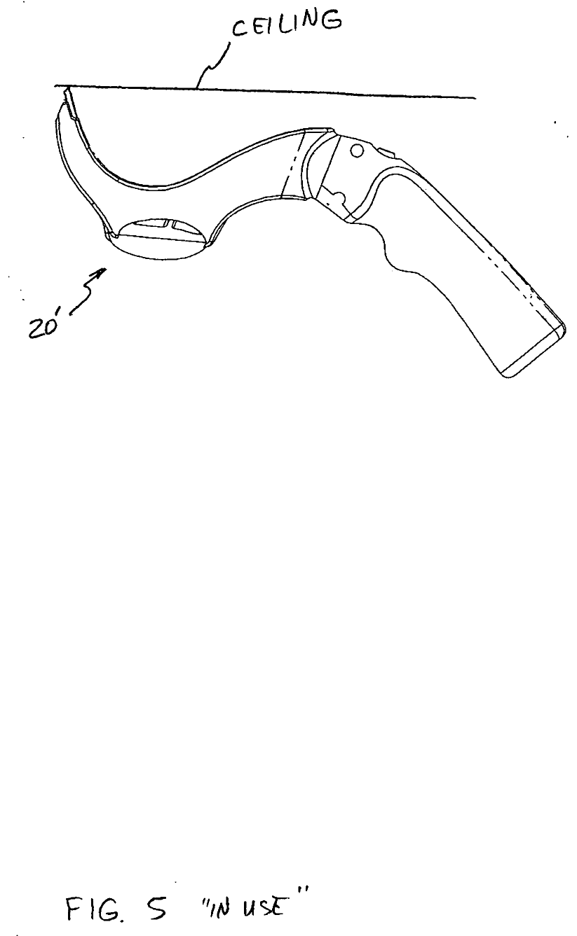

FIG. 5 shows the scraper tool 20′ in an orientation suitable for scraping a ceiling surface.

In the use of the second embodiment, the user positions himself or herself near the surface to be scraped and pivots the blade assembly 40′ to either of the two positions depicted in FIG. 4. To change the pivotal angle of the blade assembly 40′, the user grasps the scraper tool 20′ by the first handle portion with the thumb situated to depress the button 78 towards the pivotal axis 70, thereby releasing the pivot-mechanism locking assembly 76 for rotation. Then, while depressing the button 78, the user rotates the blade assembly 40′ to the desired position, where the user then releases the button 78, thereby allowing the blade assembly to become locked in place. Next, the user grips the scraper tool 20′ by the first handle portion 22′ and situates the blade member 50′ at an acute angle with the surface to be scraped, while applying a force towards the surface to be scraped through the force-transmitting portion 42′ to the blade member 50′ while translating the scraper tool 20′ back and forth along the surface to be scraped.

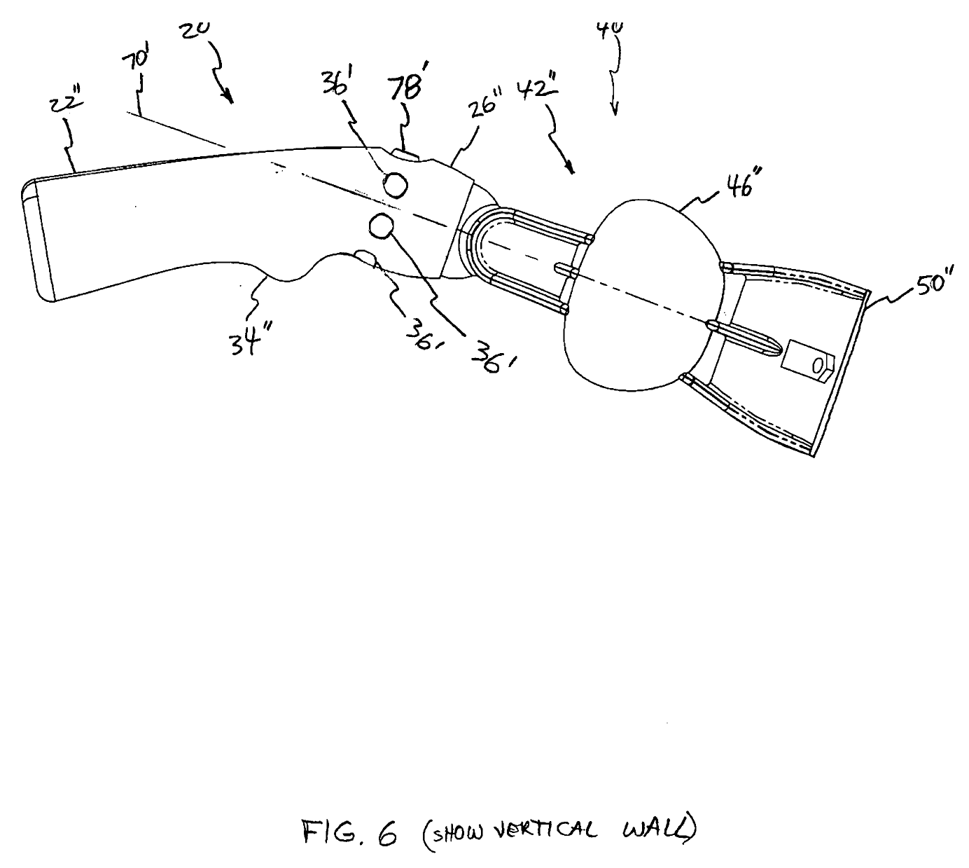

FIG. 6 shows a third embodiment of a scraper tool 20″ whereby the blade assembly 40″ has been rotated to a position suitable for the scraping of vertical walls. In this embodiment, the blade assembly may be locked in place in any of a multiplicity of positions suited to the particular user's tastes. This may be achieved, for example, by locating a multiplicity of first handle portion apertures 36′ around the periphery of a first handle portion 22″ in the vicinity of a second end of first handle portion 26″, as shown in FIG. 6. The user's choice of position may be influenced by the constraints of the particular scraping situation, such as the angle of the surface to be scraped, as well as the level, relative to the user's immediate position, at which the scraping is occurring.

In the use of the third embodiment, the user positions himself or herself near the surface to be scraped and pivots the blade assembly 40″ to a position best suited for the particular scraping task. To change the pivotal angle of the blade assembly 40″, the user grasps the scraper tool 20″ by the first handle portion with the thumb situated to depress the button 78′ towards the pivotal axis 70′, thereby releasing the pivot-mechanism locking assembly 76′ for rotation. Then, while depressing the button 78′, the user rotates the blade assembly 40″ to the desired position, where the user then releases the button 78′, thereby allowing the blade assembly to become locked in place. Next, the user grips the scraper tool 20″ by the first handle portion 22″ and situates the blade member 50″ at an acute angle with the surface to be scraped, while applying a force towards the surface to be scraped through the force-transmitting portion 42″ to the blade member 50″ while translating the scraper tool 20″ back and forth along the surface to be scraped.

It should be understood that even though these numerous characteristics and advantages of various embodiments have been set forth in the foregoing description, together with details of the structure and function of the embodiments, the disclosure is illustrative only, and changes may be made in detail, especially in matters of shape, size and arrangement of parts within the principals of the invention(s) claimed in the appended claims to the full extent indicated by the broad general meaning of the terms in which the appended claims are expressed.

What is claimed is:

1. A scraper tool, comprising:
a substantially planar blade member having upper and lower surfaces, a front edge, and a rear portion, wherein said blade has a blade-direction located perpendicularly to said front edge and in a plane of said lower surface of said blade member;
a force-transmitting portion engaging said blade member rear portion and extending rearwardly therefrom;
a first handle portion, having a first handle portion axis, a first end and a second end, attached to said force-transmitting portion at the second end; and
said first handle portion axis makes an angle with said blade-direction of between 95° and 175°.

2. The scraper tool of claim 1 wherein,
the angle between said first handle portion axis and said blade-direction is between 120° and 165°.

3. The scraper tool of claim 1 wherein,
said first handle portion is molded of polymeric plastic material; and
said force-transmittal portion is molded of polymeric plastic material.

4. The scraper tool of claim 1 further comprising:
a blade retention mechanism for releasably attaching said blade to said force-transmitting portion; and
said force-transmitting portion contains an integral second handle portion.

5. The scraper tool of claim 1 wherein,
said first handle portion has a pistol grip and a gripping surface consisting of at least one selected from the group of surface texturing and over-molded soft material, whereby secure gripping of said scraper tool is facilitated.

6. A scraper tool of claim 1, wherein the first end of the first handle portion includes an in-handle blade-storage compartment accessible through a storage door for storing extra blade members.

7. The scraper tool of claim 4 wherein the force-transmitting portion, the first handle portion, and the second handle portion consist of a one-piece molded construction.

8. A scraper tool, comprising:
a first handle portion, having a first end, a second end, and a first handle portion axis;
a pivotal-mechanism portion, having a pivotal axis, connected to the first handle portion near the second end, wherein said pivotal axis makes an acute angle with said first handle portion axis;
a force-transmitting portion attached between the pivotal-mechanism portion and a substantially planar blade.

9. The scraper tool of claim 8 wherein said acute angle is at least 15° and no greater than 45°.

10. The scraper tool of claim 9 wherein said acute angle is at least 20° and no greater than 30°.

11. The scraper tool of claim 8 further comprising:
a second handle portion connected to said force-transmitting portion.

12. The scraper tool of claim 11 wherein:
the force-transmitting portion is formed of a one-piece molded construction; and
said second handle portion is integrally molded with the force-transmitting portion.

13. The scraper tool of claim 12 wherein:
said first handle portion has a pistol grip; and
said first handle portion and said second handle portion have gripping surfaces consisting of at least one selected from the group of surface texturing and over-molded soft material.

14. The scraper tool of claim 8 wherein the blade comprises a substantially planar blade member having upper and lower surfaces, a front edge, and a rear portion,
said blade has a blade-direction located perpendicularly to said front edge and in a plane of said lower surface of said blade member;
the force-transmitting portion engages said blade member rear portion and extends rearwardly therefrom;
a blade retention mechanism which releasably attaches said blade to said force-transmitting portion.

15. The scraper tool of claim 14 further comprising:
an angle between said pivotal axis and said blade-direction such that the angle is at least 30° and no greater than 70°.

16. The scraper tool of claim 14 further comprising:
an angle between said pivotal axis and said blade-direction such that the angle is at least 40° and no greater than 65°.

17. The scraper tool of claim 14 wherein said blade retention mechanism comprises:
a blade retainer;
a blade screw; and
a blade nut.

18. The scraper tool of claim 8 further comprising:
a locking mechanism for locking said pivoting-mechanism portion in a plurality of positions relative to the first handle portion.

19. The scraper tool of claim 8 further comprising:
a releasable pivot-mechanism locking assembly, being disposed in the first handle portion, comprising one or more buttons housed within the force-transmitting portion;
a biasing mechanism for resiliently biasing the buttons outwardly from the pivot axis toward an outer surface of the first handle portion,
each said button having a head portion of smaller dimension than a shoulder portion, said head portion capable of being receivable in and protruding through one or more apertures in the first handle portion while said button is retained by said shoulder portion resting on an inside surface of said first handle portion.

20. The scraper tool of claim 19, further comprising:
a lateral through-hole in the force-transmitting portion;
said biasing mechanism comprises a spring;
said lateral through-hole houses the spring with one shouldered button located at each end of said spring with each button head facing outwardly away from the pivot axis; and
said first handle portion has one said aperture through which a button may protrude to lock the blade in place.

21. A scraper tool, comprising:
a first handle portion, having a first handle portion axis;
a blade assembly attached thereto;
a multi-+positioning apparatus for locating said blade assembly at various angles to said first handle portion axis.

22. A scraper tool kit for use with a scraper blade, the scraper kit comprising:
a substantially planar blade member having upper and lower surfaces, a front edge, and a rear portion, wherein said blade has a blade-direction located perpendicularly to said front edge and in a plane of said lower surface of said blade member;
a force-transmitting portion engaging said blade member rear portion and extending rearwardly therefrom;
a first handle portion, having a first handle portion axis, a first end and a second end, attached to said force-transmitting portion at the second end;
said first handle portion axis makes an angle with said blade-direction of between 95° and 175°; and
replacement blades.

23. A method of using the scraper tool of claim 19 comprising:
pressing the one or more button heads so that they no longer protrude through said one or more apertures in the first handle portion; while
rotating said force-transmitting portion with respect to said first handle portion;
repeating said pressing and said rotating steps until the blade of the scraper is in the desired orientation with respect to the first handle portion; and
releasing said one or more button heads so that they protrude through said one or more apertures in the first handle portion thereby locking said force-transmitting portion in place with respect to said first handle portion.
